(19) United States
(12) Patent Application Publication
(10) Pub. No.: US 2008/0256186 A1
(43) Pub. Date: Oct. 16, 2008

(54) Collaboration system

(76) Inventor: Thomas W. Hartmann, Loveland, CO (US)

Correspondence Address: CR MILES, P.C.;CRAIG R. MILES, 405 MASON COURT, SUITE 119, FORT COLLINS, CO, 80524, US

(21) Appl. No.: 12/082,479

(22) Filed: Apr. 11, 2008

Related U.S. Application Data
(60) Provisional application No. 60/923,152, filed on Apr. 12, 2007.

(51) Int. Cl. G06F 15/16

(52) U.S. Cl. 709/205

(57) ABSTRACT

A computer-based design collaboration system and method of collaborative computer-based design which allows a plurality of computers to concurrently generate a plurality of derivatives of a continuously updated design model each derivative design model delivered to one or more of the plurality of computers based on ownership of the design model to obtain the owner's consent to the derivative model with any conflicts to consent resolved prior to generating any further updated design model.

### I. BACKGROUND

Generally, a computer-based design collaboration system and method of collaborative computer-based design which allows a plurality of computers to concurrently generate a plurality of derivatives of a continuously updated design model each derivative design model delivered to one or more of the plurality of computers based on ownership of the design model to obtain the owner's consent to the derivative model with any conflicts to consent resolved prior to generating the updated design model.

A finished product in the steel building market is an erected steel frame structure which can include columns, beams, braces, joists, and decking along with edge angle and other components necessary to complete a stable steel structure. The complete steel structure is turned over to the general contractor for further construction processing, including casting concrete on the metal decks, exterior cladding, interior services such as HVAC, plumbing, electrical, partitions, and other finishes desired in the completed steel frame product.

The delivery of the steel frame structure is nearly always identified on the “critical path” of construction. Accordingly, delivery of the steel frame structure represents an opportunity for improved trade flow by the steel frame product construction supply chain. The steel frame structure construction supply chain has a delivery system constrained by a large number of small, geographically dispersed consulting engineers, steel detailers, steel fabricators, and steel erectors which in serial priority obtain possession of the design model (each having obtained prior contractual authority to have possession of the design model). Requests to change the design model by each possessor of the design model are typically made to a general contractor which in turn obtains consent from the owner of the building to recover any additional costs. An advantage to this conventional type of steel frame structure delivery process (the “General Contractor Process”) can be control over the final cost. However, control over the final cost comes at the expense of an increased duration of time for delivery of the steel frame structure and the introduction of lowest cost subcontractors.

An impediment to providing an alternative to the General Contractor Process may be the lack of a computer-based design model which allows each of the consulting engineers, steel detailers, steel fabricators, and steel erectors, or other professions to concurrently generate a plurality of derivatives of the design model to address problems with respect to cost, quality, and scheduling deliverables within the steel frame structure delivery process. While certain conventional Internet-based collaborative design environments have been described which provide a central server which can be accessed and can serve an electronic design model to a plurality of networked computers, see for example U.S. Pat. No. 6,928,396 to Thackston, these conventional collaborative design environments may not assign ownership of each of the concurrently generated derivative design models and do not deliver each succeeding generation of derivative design model to the correct prior generation of derivative design model owner(s).

Another substantial impediment to conventional collaborative design processes can be that at least one of the design collaborators must obtain approval of the steel frame product owner to any derivative design model. Accordingly, while derivative design models may be generated concurrently, consent to the each design iteration remains serial and outside of the collaborative design process. As a result, conventional collaborative design processes can lack a consent function which allows the design model to be updated with altered design elements of a derivative design model. Additionally, conventional collaborative design processes can lack a function to deliver a derivative design model to the owner of a prior derivative design model or to the owner of the original design model because consent to update the design model with the altered design elements to produce an authorized version of an updated design model which can be republished in the collaborative design environment cannot be obtained without approval of the owner of the building.

Related to this substantial problem can be that certain conventional software applications may provide only file level data change management. Common examples include applications such as Autodesk “Buzzsaw”, ftp websites and even automated e-mail programs that launch upon data change events. In these examples, the author's ownership of the data element may be maintained through file system access rights and the right to use data access which allows derivative data elements to be generated in serial fashion similar to VCR video tape access, as an example. However, none of these conventional file sharing applications or file sharing environments allows concurrent non-serial design model access by a plurality of computer users each having a right to alter the design model or any of a plurality of derivative models within the scope of a prior consent by the owner of the accessed design model or derivative model.

Another substantial impediment to conventional collaborative design processes can be a lack of an arbitrator function which resolves conflicts with regard to consent to update the design model. Typically, a conflict between two or more of the professionals participating in a design collaboration as to consent to a particular derivative design model is resolved in serial order outside of the collaborative design environment. As such, conventional collaborative design applications lack an arbitration function which operates to resolve the conflict between collaborators as to any one or a plurality of the derivative design models. Design element (also referred to as “a design value” as defined below) and design element change arbitration has been developed to manage “open source” computer code such as Linux. Example source code arbitrator programs include “CVS” and “Subversion”. However, these conventional arbitrator programs which allow authors to “commit” changes from derivative works into the primary source code and do not address the need to arbitrate a plurality of conflicting design element changes between a plurality of computers or computer users to update a single design model.

To address the unresolved problems of conventional collaborative design processes above-described the instant inventive collaborative design system provides numerous and varied operating functions which allows concurrent development of the design model by a plurality of professions uninterrupted by having to seek consent to derivative design models or arbitration of conflicts in serial order outside of the authorized collaborative design network.

### II. SUMMARY OF THE INVENTION

Accordingly, a broad object of the invention can be to provide a design collaboration application which can be served to one or a plurality of subscriber computers connected to the server computer over a network which allows each of the plurality of subscriber computers connected to the server computer to concurrently access a design model stored in a memory element of the server computer such that one or a plurality of derivative design models of the design model can concurrently generated by each one of the plurality of subscriber computers.

Another broad object of the invention can be to provide the above described design collaboration application which further functions to couple an ownership identification element to each of the design values alterable by operation of the design collaboration application and which can further function to identify altered design values.

Another broad object of the invention can be to provide the above described design collaboration application which further functions to match each ownership identification element with the corresponding one of the plurality of subscriber computers such that one or a plurality of design values within one or plurality of derivative design models can be identified and matched to an owner of the design value in each of the plurality of derivative design models.

Another broad object of the invention can be to provide the above described design collaboration application which further functions to concurrently deliver each of the plurality of derivative design models which include an altered design value to the each owner of a design model or a derivative design model which includes a design value to be altered.

Another broad object of the invention can be to provide the above described design collaboration application which further functions to concurrently arbitrate conflicts with respect to obtaining consent to update the design model with any one of a plurality of altered design values of the plurality of derivative design models and priority order the plurality of consented to altered design values to update the design model.

Naturally, further objects of the invention are disclosed throughout other areas of the specification, drawings, photographs, and claims.

### III. A BRIEF DESCRIPTION OF THE DRAWINGS

FIG. 1 is a block diagram of hardware means, software means, and network means which may be utilized to practice various embodiments of the invention.

FIG. 2 is a block diagram of a particular method of utilizing a particular embodiment of the inventive design collaboration program.

FIG. 3 is a block diagram of a particular method of utilizing a particular embodiment of the inventive arbitrator module.

### IV. DETAILED DESCRIPTION OF THE PREFERRED EMBODIMENTS

According to various embodiments of the invention, the shortcomings of conventional collaborative design processes are addressed by providing a computer implemented design collaboration system and computer implemented method of collaborative design which allows a plurality of computers to concurrently generate a plurality of derivative design models of a continuously updated design model each derivative design model delivered to one or more of the plurality of computers based on ownership of the design model to obtain the consent of the owner to the derivative design model with any conflicts to consent resolved prior to generating a the updated design model.

The present invention may be described herein in terms of functional block components, screen shots, optional selections and various processing steps. It should be appreciated that such functional blocks may be realized by any number of hardware or software components configured to perform the specified functions. For example, the present invention may employ various integrated circuit components which function without limitation as memory elements, processing elements, logic elements, look-up tables, or the like, which may carry out a variety of functions under the control of one or more microprocessors or other control devices.

Similarly, the software elements of the present invention may be implemented with any programming or scripting language such as C, C++, Java, COBOL, assembler, PERL, Labview or any graphical user interface programming language, extensible markup language (XML), Microsoft's Visual Studio .NET, Visual Basic, or the like, with the various algorithms or Boolean Logic being implemented with any combination of data structures, objects, processes, routines or other programming elements. Further, it should be noted that the present invention might employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

As will be appreciated by one of ordinary skill in the art, the present invention may be embodied as a method, a data processing system, a device for data processing, a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, ROM, flash RAM, and/or the like.

The present invention may be described herein with reference to screen shots, block diagrams and flowchart illustrations of the design collaboration system or design collaboration computer programs, applications, or modules which can be utilized separately or in combination with such design collaboration system in accordance with various aspects or embodiments of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware based computer systems which perform the specified functions or steps, or suitable combinations of special purpose hardware and computer instructions.

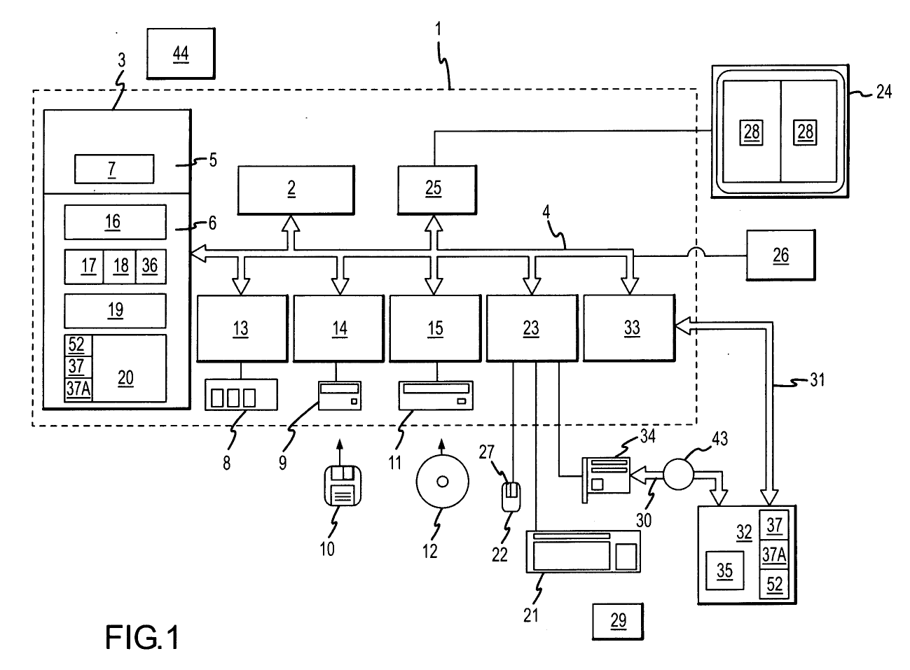

Now referring primarily to FIG. 1, which shows a block diagram of a non-limiting embodiment of the invention, a server computer (1) provides at least one processing unit (2), a memory element (3), and a bus (4) which operably couples components of the server computer (1), including without limitation the memory element (3) to the processing unit (2). The server computer (1) may be a conventional computer, a distributed computer, or any other type of computer; the invention is not so limited. One example of a server computer (1) suitable for use with embodiments of the invention can be a Linux computer. The processing unit (2) can comprise one central-processing unit (CPU), or a plurality of processing units which operate in parallel to process digital information. The bus (4) may be any of several types of bus configurations including a memory bus or memory controller, a peripheral bus, and a local bus using any of a variety of bus architectures. The memory element (3) can without limitation be a read only memory (ROM) (5) or a random access memory (RAM) (6), or both. A basic input/output system (BIOS) (7), containing routines that assist transfer of data between the components of the server computer (1), such as during start-up, can be stored in ROM (5). The server computer (1) can further include a hard disk drive (8) for reading from and writing to a hard disk (not shown) a magnetic disk drive (9) for reading from or writing to a removable magnetic disk (10), and an optical disk drive (11) for reading from or writing to a removable optical disk (12) such as a CD ROM or other optical media.

The hard disk drive (8), magnetic disk drive (9), and optical disk drive (10) can be connected to the bus (4) by a hard disk drive interface (13), a magnetic disk drive interface (14), and an optical disk drive interface (15), respectively. The drives and their associated computer-readable media provide nonvolatile storage of computer-readable instructions, data structures, program modules and other data for the server computer (1). It can be appreciated by those skilled in the art that any type of computer-readable media that can store data that is accessible by a computer, such as magnetic cassettes, flash memory cards, digital video disks, Bernoulli cartridges, random access memories (RAMs), read only memories (ROMs), or the like, may be used in embodiments of the operating environment.

A number of design collaboration application modules may be stored on the hard disk, magnetic disk (10), optical disk (12), ROM (5), or RAM (6), along with an operating system (16) (certain non-limiting examples include Fedora Core 3, CentOS, or Red Hat Linux), one or a plurality of other application programs (17) (one non-limiting example includes Gforge which provides Apache web services, Mailman list services, Subversion version control, and PostgreSQL database services using PHP, JavaScript, HTML, SQL/PL and CSS programming), and without limitation the design collaboration program (18) along with program interfaces (36), other program modules (19), and program data (20) which includes in part design collaboration program data (20) including the design model (37), the derivative design models (37A) and the updated design model (52). A computer user (29) may enter commands and information into the server computer (1) through input devices such as a keyboard (21) and pointing device such as a mouse (22). Other input devices (not shown) may include a microphone, joystick, game pad, satellite dish, scanner, or the like. These and other input devices are often connected to the processing unit (2) through a serial port interface (23) that can be coupled to the bus (4), but may be connected by other interfaces, such as a parallel port, game port, or a universal serial bus (USB). A monitor (24) or other type of display device can also be connected to the bus (4) via interfaces such as a video adapter (25), or the like. In addition to the monitor (24), the server computer (1) can further include other peripheral output devices (26), such as speakers, printers, or the like.

A “click event” occurs when the user (29) operates an application function through the use of a command which for example can include pressing or releasing the left mouse button (27) while a pointer is located over a control icon (28) displayed by the monitor (24). However, it is not intended that a “click event” be limited to the press and release of the left button (27) on a mouse (22) while a pointer is located over a control icon (28), rather, a “click event” for the purposes of this invention is intended to broadly encompass any manner of command by the user (29) by which a function of an application program (17) including without limitation a function of the design collaboration program (18) is activated or performed, whether through clickable selection of one or a plurality of control icon(s) (28) or by user voice command, keyboard stroke(s), mouse button, touch screen, or otherwise. It is further intended that control icons (28) can be configured without limitation as a point, a circle, a triangle, a square (or other geometric configurations or combinations or permutations thereof), or as a check box, a drop down list or other index containing a plurality of identifiers clickably selectable, an information field which can contain or which allow input of a string of characters such as a street address, zip code, county code, or natural area code, or by inputting a latitude/longitude or projected coordinate X and Y, or other notation, script or character, or the like.

Additionally, the server computer (1) may operate in a networked environment using logical connections (30)(31) to one or a plurality of subscriber computers (32). These logical connections (30)(31) are achieved by a communication device (33) coupled to or a part of the server computer (1); the invention is not limited to a particular type of communications device (33). Each of the plurality of subscriber computers (32) can be a computer, a server, a router, a network PC, a peer device or other common network node, and can include a part or all of the elements above-described relative to the server computer (1) although only a second computer memory element (35) and has been illustrated in FIG. 1. The logical connections (30)(31) depicted in FIG. 1 can include a local-area network (LAN) (31) or a wide-area network (WAN) (30). Such networking environments are commonplace in offices, enterprise-wide computer networks, intranets and the Internet.

When used in a LAN-networking environment, the server computer (1) can be connected to the local network (31) through a network interface or adapter, which is one type of communications device (33). When used in a WAN-networking environment, the server computer (1) typically includes a modem (34), a type of communications device, or any other type of communications device for establishing communications over the wide area network (30), such as the Internet (43). The modem (34), which may be internal or external, is connected to the bus (4) via the serial port interface (23). In a networked environment, the design collaboration program (18), program modules (19) and program data (20) depicted relative to the server computer (1), or portions thereof, may be stored in the subscriber computer (32) second computer memory element (35). It is appreciated that the network connections shown are exemplary and other hardware means and communications means for establishing a communications link between the server computer (1) and one or a plurality of subscriber computers (32) can be used.

While the computer means and the network means shown in FIG. 1 can be utilized to practice preferred embodiments of the invention including the best mode, it is not intended that the description of the best mode of the invention or any preferred embodiment of the invention be limiting with respect to the utilization of a wide variety of similar, different, or equivalent computer means or network means to practice embodiments of the invention which include without limitation hand-held devices, such as personal digital assistants or camera/cell phone, multiprocessor systems, microprocessor-based or programmable consumer electronics, network PCs, minicomputers, mainframe computers, PLCs, or the like.

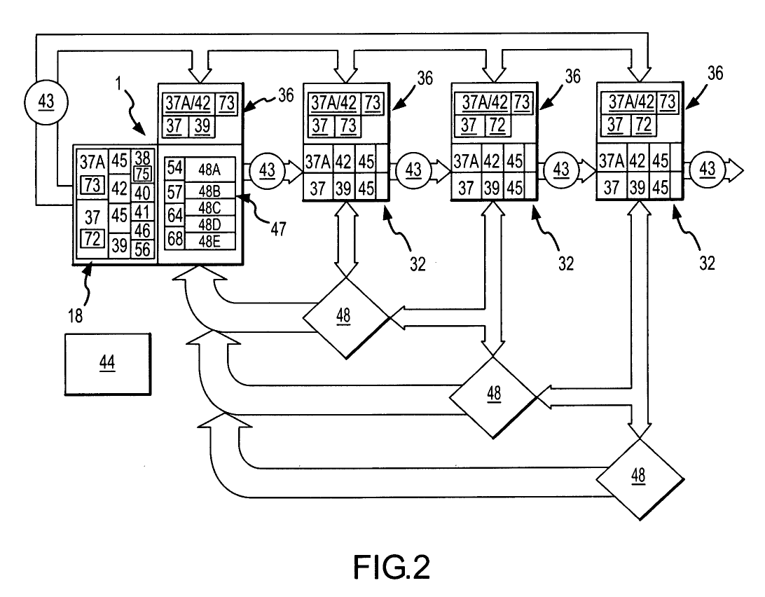

Now referring primarily to FIGS. 1 and 2, the design collaboration program (18) in part provides a design collaboration server (41) which functions to serve a design collaboration application (40). The design collaboration application (40) functions to generate a design model graphic user interface (36) which can be displayed on the monitor (24) of the server computer (1) or a plurality of subscriber computers (32). The design model graphic user interface (36) allows a computer user (29) access to the functionalities of the of the design collaboration program (18) through which the design model (37) can be retrieved from the memory element (3) of the server computer (1). A non-limiting example of an application suitable for use in embodiments of the design collaboration application (40) for generating the design model graphic user interface (36) can be Gforge a web-based project management and collaboration software. The term design model (37) broadly encompasses electronic data as design values (39) useful in the manufacture, utilization, analysis or assessment of an object (44) (such as a steel frame product as above described) including without limitation geometric coordinate values, material property values, load values, machine values, harmonic property values, construction sequence values, or similar values. Manipulation of the design values (39) of the design model (37) by utilization of the design model graphic user interface (36) activates the design collaboration application (18) which functions to allow generation of one or a plurality of derivative design models (37A).

The design collaboration application server (41) of the design collaboration program (18) can further function to provide the design model (37) or derivative design models (37A) to a plurality of subscriber computers (32) utilizing logical connections (30)(31) (LAN or WAN including without limitation the Internet (43)) which allows each of the plurality of subscriber computers (32) to utilize the design collaboration application (40) to generate the design model graphic interface (36) and manipulate the derivative design models (37A) to generate a further plurality of derivative design models (37A) which can be retrievably stored in the subscriber computer memory element (35) of the subscriber computer (32). As to certain embodiments of the invention, a suitable design collaboration server (41) can be provided by Gforge which can function to serve the design model (37) and derivate design models (37A) generated using numerous and varied design modeling softwares as further described below; however, the specific example of Gforge is not intended to be limiting and other applications can be utilized which can function to serve the design model (37) or any of a plurality of derivate design models (37A).

The design collaboration application (40) can further include a design model translation module (38) which functions to translate the design model (37) in a first design model format (72) to a design model (37) in a second design model format (73) to allow viewing or generation of a plurality of derivative design models (37A) in the second design format (73) by each one of the subscriber computers (32). The design model translation module (38) can further function to translate the design model (37) in a second design format (73) to the design model (37) in the first design model format (72). Understandably, the design model translation module (38) can further translate the design model (37) or a derivative design model (37A) from a second design format to a third design format and a back to any of the prior design model formats as required. The term “first design format” for the purposes of this invention means the design model (37) generated in a format which allows manipulation by the functionalities of a first design model software whether by the server computer (1) or any one of the plurality of subscriber computers (32). The term “second design format” for the purposes of this invention means the design model generated in a format which allows manipulation by the functionalities of a second design model software whether by the server computer (1) or any one of the plurality of subscriber computers (32). Translation of the design model (37) between a first design model format (72) and a second design model format (73) allows a plurality of specialists in different fields to collaboratively participate in the design the object (44) (such as a steel frame structure or steel frame product above described) utilizing a plurality of different design modeling softwares. For example, in the design of steel frame structures or steel frame products, the designer, the detailer, the fabricator, and the erector may each utilize a different design modeling software each of which generate a correspondingly different design format of the design model (37) or any of the plurality of derivate design models (37A). Without the functionalities of the design model translation module (38), as to the design of a steel frame structure for example, each of the designer, the detailer, the fabricator, and the erector would likely be unable to alter design values (39) in the design model (37) utilizing a design modeling software different from the design modeling software used to produce the prior iteration of the design model (37) or any one of the plurality of derivative design models.

Table 1 provides specific non-limiting examples of a first design model format (72) and a second design model format (73) which can be matched by the design model translation module (38) to allow direct translation of the design model from the first design model format (72) to the second design model format (73). Tables 2-4 each provide specific examples of a first design model format (72) and a second design model format (73) which may require a design model translation interface (75) to convert the first design model format (72) (the first listed design modeling software in a row) to the second design model format (73) (the last listed design modeling software in a row). The “design model translation interface (75)” for the purposes of this invention can mean the first design model format (72) matched by the design model translation module (38) to all the necessary intermediary design modeling software formats and to the second design model format (73) to allow translation from the first design model format (72) to the second design model format (73) and can mean as to certain embodiments of the invention in which the first design format (72) cannot be translated to the second design format (73) through use of other intermediate design modeling software, a specific design model translation interface application matched by the design model translation module (38) to translate a first design format (72) to a second design format (73).

TABLE 1

| FIRST DESIGN FORMAT | SECOND DESIGN FORMAT |
|---|---|
| Bentley STAAD.Pro | Autodesk Revit |
| CSC Fastrak | Revit |
| CSC Fastrak | Autocad 3D |
| CSC Fastrak | Graphisoft Archicad |

TABLE 2

| | DESIGN FORMAT | SECOND DESIGN |
|---|---|---|
| FIRST DESIGN FORMAT | INTERFACE | FORMAT |
| STAAD | CIS/2 | SDS/2 |
| STAAD | CIS/2 | Graitec Advance Steel |
| Fastrak | SDNF | Tekla |
| Fastrak | SDNF | SDS/2 |
| Fastrak | SDNF | Graitec Advance Steel |
| RISA3D | SDNF | Tekla |
| RISA3D | SDNF | SDS/2 |
| RISA3D | SDNF | Graitec Advance Steel |
| Fastrack | Revit | Fastrak |
| RAM | Revit | RAM |
| RAM | Autocad | RAM |

TABLE 3

| | DESIGN FORMAT | | SECOND DESIGN |
|---|---|---|---|
| FIRST DESIGN FORMAT | INTERFACE | | FORMAT |
| Bentley STAAD | CIS/2 | IFC | Autodesk Revit |
| STAAD | CIS/2 | IFC | Graphisoft Archicad |
| Bentley Ram | CIS/2 | IFC | Autodesk Revit |
| Revit | Fastrak | Revit | Fastrak etc. |

TABLE 4

| FIRST DESIGN | | | | SECOND DESIGN |
|---|---|---|---|---|
| FORMAT | DESIGN FORMAT INTERFACE | | | FORMAT |
| Bentley Ram | Bentley RamAdvanse | SDNF | CSC Fastrak | Autodesk Revit |

Again referring primarily to FIGS. 1 and 2, a derivative design model (37A) includes an altered design value (42) (or more than one altered design value) of a corresponding design value (39) of the design model (37) or a derivative design model (37A). As a non-limiting example, the design model (37) (or a derivative design model (37A)) can include a design value (39) which correspondingly matches to iron metal. If this design value (39) for iron metal is replaced in the design model (37) by an altered design value (42) which correspondingly matches to an aluminum metal a derivative design model (37A) has been generated and can be saved in the memory element (3) of the server computer (1) or the second computer memory element (35) of a subscriber computer (32). Understandably, a derivative design model (37A) can have one or more design values (39) altered in comparison to the design model (37) or prior derivative design model (37A).

Because each of the plurality of subscriber computers (32) can each generate one or more than one derivative design model (37A) having one or more altered design value(s) (42) (whether generated in serial or in parallel events) the design collaboration application (18) can further include an design value ownership identification module (46) which functions depending upon the embodiment of the invention to couple to each design model (37), derivative design model (37A) or to each design value (39) or altered design value (42) in the design model (37) or the derivative design model (37A) a design value ownership identifier (45) correspondingly matched to the server computer (1) or one of the subscriber computers (32) (each of the server computer (1) and each of the subscriber computers (32) having a unique design value ownership identifier (45)). As to certain embodiments of the invention the design value ownership identifier (45) can be matched to one each of a plurality of users (29) rather than to the server computer (1) or one of the subscriber computers (32). For example, upon establishing a design value (39) in the design model (37) by the server computer (1) the design value ownership identification module (46) can function to couple the corresponding design value ownership identifier (45) for the server computer (1) or one of the subscriber computers (32) to the design value (39) at the time the design model (37) is stored to the memory (6). Any subsequent alteration of that design value (39) of the design model (37) to generate a derivative design model (37A) activates the design value ownership identification module (46) which couples a new design value ownership identifier (45) corresponding to the server computer (1) or any one of the subscriber computers (32) (or computer users (29)) to the altered design value (42) such that the ownership of any altered design value (42) can be assigned to the server computer (1) or one of the plurality of subscriber computers (32) in which the design value (39) was altered.

As a non-limiting example, embodiments of the design collaboration application (40) can coordinate the functionalities of Gforge and Subversion, a version control application, to maintain current and historical versions of the design model (37) and the derivative design models (37A). For example, a recent version of Subversion can make a ‘copy’ to the new design value ownership identifier (45) followed by a ‘delete’ of the old design value ownership identifier (45). Only the design value ownership identifier (45) changes, all data relating to the edit history remains the same. In practice ownership of the design model (37) or derivatives of the design model (37A) can be identified with either the server computer (1), the subscriber computer (32) or the computer user (29). The design model (37) and all derivate design models (37A) can reside in a repository in the memory element (3) of the server computer (1).

Now referring primarily to FIGS. 1-3, the design collaboration program (18) further functions to provide an arbitrator module (47) which functions to receive one or more design model alteration requests (48) from the server computer (1) or any one or more of the plurality of subscriber computers (32). The arbitrator module (47) further functions based upon consent from the owner (69) of the design model (37) or the derivative design model (37A) to accept or reject the altered design value (42) in any particular derivative design model (37A). Acceptance by the arbitrator module (47) activates a design model update module (56) which functions to update the design model (37) with each accepted altered design value (42). The term “consent” for the purposes of this invention means a prior permission granted by the owner (69) of the design model (37) or any derivative design model (37A) which allows alteration of a design value (39) within the design model (37) or the derivative design model (37A) by another, or alternately can mean a permission granted to another upon submission of the design model (37) or the derivative design model (37A) to the owner of the design model (37) or the derivative design model (37A) by another. The term “owner” for the purposes of this invention means the computer user (29) or server computer (1) or subscriber computer (32) matched to the design model (37) or derivative design model (37A) in which a design value (39) is being altered by another.

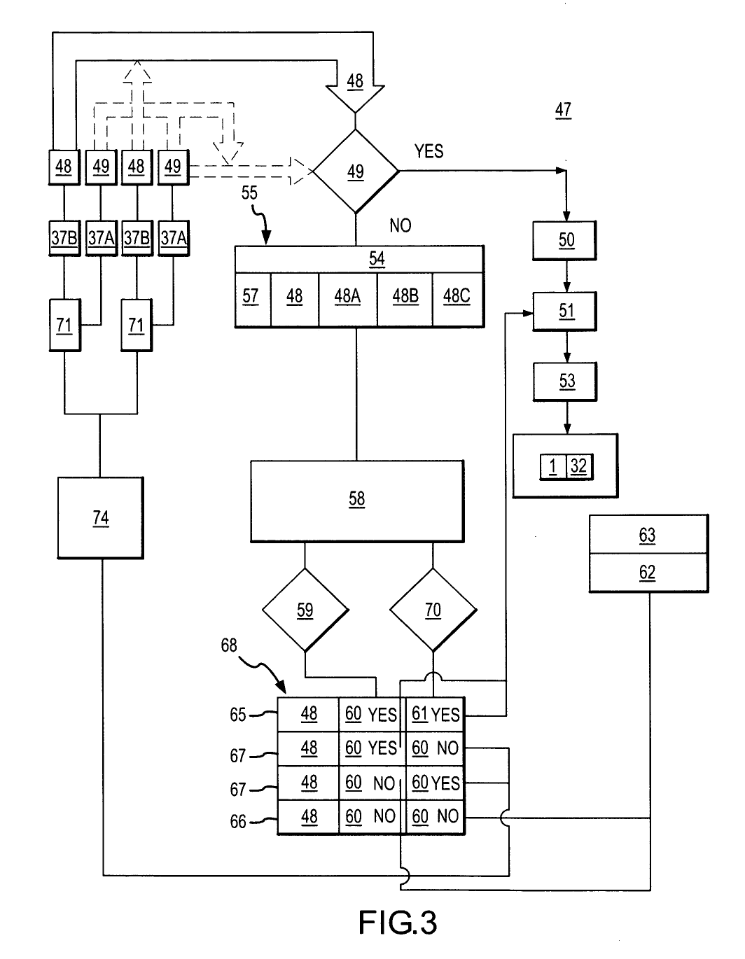

Now referring primarily to FIG. 3, a flow diagram shows the stepwise functionalities of the arbitrator module (47) upon receiving a design model alteration request (48). The term design model alteration request (48) for the purposes of this invention means a click event by a computer user (29) of the design collaboration application (40) which activates functionalities of the arbitrator module (47) to obtain consent to update the design model (37) with altered design values (42). In a first arbitration step (49), the arbitrator module (47) functions to determine ownership of the derivative design model (37A) having the altered design value (42). The ownership determination can be based upon matching the design value ownership identification identifier (45) of a design value (39) (or the design model (37) or the derivative design model (37A) which has been altered to the corresponding server computer (1) or subscriber computer (32) (or the computer user (29)), as above described. If the ownership determination as to the design value (39) which has been altered resides in the same server computer (1) or subscriber computer (32) which generated the design model alteration request (48) (determination is “yes”), then in a second arbitration step (50), the arbitration module functions to allow the server computer (1) or subscriber computer (32) generating the design model alteration request (48) to consent to updating the design model with the altered design value (42). Upon receiving consent of the server computer (1) or one of the subscriber computers (32) to the design model alteration request (48) (depending upon ownership of the design model (37) (or the derivative design model (37A)), then in a third arbitration step (51) the design model update module (56) updates the design model (37) with the altered design value (42) and stores an updated design model (52) in the memory element (3) of the server computer (1) or the subscriber computer (see FIG. 1). In a fourth arbitrator step (53), the updated design model (52) can be served by the design collaboration application server (41) to the server computer (1) or any one or all of the subscriber computers (32).

Again referring primarily to FIGS. 1-3, if the server computer (1) or any one of the subscriber computers (32) which generated the design model alteration request (48) does not also own the design value (39) altered (determination is “no”) than the arbitrator module (47) functions in a fifth arbitration step (55) to store each such design model alteration request (48)(48A)(48B)(48C) in a design model alteration request queue (54). The order priority of each of the plurality of design model alteration requests (48)(48A)(48B)(48C) in the design model alteration request queue (54) can be established by order priority rules (57). Based on application of the order priority rules (57) (typically serial time order), in a sixth arbitrator step (58), the arbitrator module (47) functions to allow the design collaboration application server (41) to serve in priority order each design model alteration request (48) to the server computer (1) or the subscriber computer (32) which owns the design value (39) altered in the derivative model (37A). In an seventh arbitrator step (59), the arbitrator module (47) allows each of the server computer (1) or the subscriber computer (32) (or computer user (29)) which owns the design value (39) altered in the derivative model (37A) to consent to an altered design value (42) (shown in the second column of the owner consent match table (68) “yes”) or to reject (shown in the second column of the owner consent match table (68) as “no”) the altered design value (42) in the derivate design model (37A) of the design model alteration request (48). If the server computer (1) or the subscriber computer (32) which owns the design value (39) altered provides a consent (60) (“yes”) to the altered design value (42) in the derivate design model (37A) (served serially based on priority order rules (57)), then the design model update module (56) updates the design model (37) or the derivate design model (37A) with the altered design value (42) and stores the updated design model (52) in the memory element (3) of the server computer (1) or the second computer memory element (35) of a subscriber computer (32), as above-described in the third arbitration step (51). The updated design model (52) can be served by the design collaboration application server (41) to the server computer (1) or any one or all of the subscriber computers (32), as described in the fourth arbitration step (53). If on the other hand, the server computer (1) or the subscriber computer which owns the design value (39) altered acts by click event to reject (61) (“no”) the altered design value (42), then the arbitrator module (47) functions in an eighth step (62) to serve a design model alternation request rejection notice (63) to the server computer (1) or the subscriber computer which made the design model alteration request (48). In this case the design model (37) is not updated.

Again referring primarily to FIGS. 1-3, the arbitrator module (47) can further provide an ownership conflict resolution module (64) which in the event that the server computer (1) and one or more of the subscriber computers (32) or more than one subscriber computer (32) owns the same design value (39) altered operates in a ninth step (70) to match the corresponding click events to consent to or to reject the altered design value (42) in the owner consent match table (68). Referring to the second and third column of the owner consent match table (68), if there is not a unanimous consent (65) (see first row of the owner consent match table (68)) or a unanimous rejection (66) (see last row of owner consent match table (68)) of an altered design value (42) by each of the server computer (1) and each subscriber computer (32) which own the design value (39) altered then a conflict condition (67) (see for example the second and third rows of the owner consent match table (68)) occurs and the arbitrator module (47) functions in an tenth step (74) to serve a conflict notice (71) to each of the server computer (1) and each subscriber computer (32) which own the design value (39) allowing a response in a first alternative of a revised derivative design model (37B) of the altered design value (42). The revised derivative design model (37B) is then submitted to each of the server computer (I) or the subscriber computer (32) which owns the design value (39) altered in the revised derivative model (37B) to consent to or reject the altered design value (42) in the revised derivate design model (37B) of the design model alteration request (48) as above described. In a second alternative the derivative design model (37A) can again be submitted into the first step (49) of the arbitrator module (47) as above described. This conflict resolution process repeats as is necessary to resolve the conflict between more than one owner (69) in design value (39) altered in the design model (37) or a derivative design model (37A) and to update the design model in the third step (51) as above-described.

As can be easily understood from the foregoing, the basic concepts of the present invention may be embodied in a variety of ways. The invention involves numerous and varied embodiments of design collaboration system and methods of making and using such design collaboration system. As such, the particular embodiments or elements of the invention disclosed by the description or shown in the figures accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of an “design model” should be understood to encompass disclosure of the act of “design modeling” whether explicitly discussed or not and, conversely, were there effectively disclosure of the act of “design modeling”, such a disclosure should be understood to encompass disclosure of a “design model” and even a “means for design modeling.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

Thus, the applicant(s) should be understood to claim at least: i) each of the design collaboration systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof or to obtain any benefit of reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth below, if any, are intended describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A computer implemented method of collaborative design, comprising the steps of:
a) storing a design model in a memory element of a server computer;
b) serving a design collaboration application with said server computer to allow a plurality of subscriber computers connected to said server computer to obtain said design model in a first design model format;
c) translating said design model in said first design model format with said design collaboration application to said design model in a second design model format to allow each of said plurality of subscriber computers to generate a plurality of derivative design models in said second design format;
d) storing at least a portion of said plurality of derivative design models in said second design format generated by said plurality of subscriber computers in said first memory element of said server computer;
e) obtaining consent of an owner of said design model to update said design model with altered design values of any one of said plurality of derivative design models;
f) translating the one of said plurality of derivative design models in said second design model format stored in said server computer with said design collaboration application to a corresponding one of said plurality of derivate design models in said first design format; and
g) updating said design model with said altered design values of the one of said plurality of derivative design models.

2. The computer implemented method of collaborative design as described in claim 1, further comprising the step of storing said plurality of derivative design models in said second design format in a subscriber computer memory element of a first one of said plurality of subscriber computers.

3. The computer implemented method of collaborative design as described in claim 2, further comprising the step of serving one of said plurality of derivate design model models in said second design format from said subscriber computer memory element of said first one of said plurality of subscriber computers to a second one of said plurality of subscriber computers.

4. The computer implemented method of collaborative design as described in claim 3, further comprising the step of translating said design model in said second design model format with said design collaboration application to said design model in a third design model format to allow said second one of said plurality of subscriber computers to generate a plurality of derivative design models in said third design format.

5. The computer implemented method of collaborative design as described in claim 4, further comprising the step of storing at least a portion of said plurality of derivative design models in said third design format generated by said second one of said plurality of subscriber computers in said subscriber computer memory element of said first one of said plurality of subscriber computers.

6. The computer implemented method of collaborative design as described in claim 5, further comprising the step of obtaining consent of an owner of said one of said plurality of derivative design models in said second design format to update said one of said plurality of design models in said second design format with altered design values of any one of said plurality of derivative design models in said third design format.

7. The computer implemented method of collaborative design as described in claim 6, further comprising the step of translating the one of said plurality of derivative design models in said third design model format stored in said subscriber computer memory element of said first one of said plurality of subscriber computers with said design collaboration application to a corresponding one of said plurality of derivate design models in said second design format.

8. The computer implemented method of collaborative design as described in claim 7, further comprising the step of updating said design model in said second design format stored in said subscriber computer memory element of said first one of said plurality of subscriber computers with said altered design values of the one of said plurality of derivative design models.

9. The computer implemented method of collaborative design as described in claim 8, further comprising the step of serving said design model in said second design format stored in said subscriber computer memory element of said first one of said plurality of subscriber computers with said altered design values of the one of said plurality of derivative design models to said server computer.

10. The computer implemented method of collaborative design as described in claim 9, further comprising the step of coupling to each said design model an ownership identification element which allows identification of said owner of said design model.

11. The computer implemented method of collaborative design as described in claim 10, further comprising the step of coupling to each of said plurality of derivative design models an ownership identification element which allows identification of said owner of each of said plurality of derivative design models.

12. The computer implemented method of collaborative design as described in claim 11, further comprising the step of routing each one of said plurality of derivative design models to a corresponding one said owner based upon said ownership identification element to obtain consent of said owner to update said design model.

12. The computer implemented method of collaborative design as described in claim 12, further comprising the step of transferring ownership of said altered design values to said owner which consents to update said design model.

13. The computer implemented method of collaborative design as described in claim 13, wherein said step of transferring ownership of said altered design values to said owner which consents to update said design model comprises replacing said ownership identification element of said one of said plurality of derivative design models having altered design values to said ownership identification element corresponding to said owner which consents to update said design model.

14-25. (canceled)
